(19) United States
(12) Patent Application Publication
(10) Pub. No.: US 2025/0279634 A1
(43) Pub. Date: Sep. 4, 2025

(54) Expandable Panelboard Bus Assemblies and Methods of Assembling Same

(71) Applicant: ABB Schweiz AG, Baden (CH)

(72) Inventors: Shawn Couceiro Fonseca, Bloomfield, CT (US); Erik Ryan Khzouz, Bloomfield, CT (US); Justin Daniel Dubrosky, Bloomfield, CT (US); Dana Edmond Foster, Bloomfield, CT (US); Julia Colleen Oppenheimer, Bloomfield, CT (US); Kiran Bhattar, Hyderabad (IN)

(21) Appl. No.: 18/591,608

(22) Filed: Feb. 29, 2024

(51) Int. Cl. H02B 1/20; H02B 1/015

(52) U.S. Cl. CPC H02B 1/20; H02B 1/015

(57) ABSTRACT

An expandable electrical panelboard system is provided. The panelboard system includes a panelboard bus assembly. The panelboard bus assembly includes a bus subassembly including one or more busbar insulators and one or more panelboard busbars at least partially enclosed in the one or more busbar insulators. The panelboard bus assembly also includes an expansion subassembly including one or more expansion busbars. The one or more expansion busbars are electrically conductive and at least partially exposed. The bus subassembly is configured to mechanically and electrically couple with another bus subassembly via the expansion subassembly.

### BACKGROUND

The field of the disclosure relates generally to electrical power delivery, and more particularly, to electrical panelboard systems, panelboard bus assemblies, and methods of assembling panelboard systems and assemblies.

A panelboard system in a power system is used to control the delivery of power from a power source to consumers. A panelboard system includes a panelboard bus assembly for transmitting electricity. Known panelboard systems are disadvantaged in some aspects and improvements are desired.

### BRIEF DESCRIPTION

In one aspect, an expandable electrical panelboard system is provided. The panelboard system includes a panelboard bus assembly. The panelboard bus assembly includes a bus subassembly including one or more busbar insulators and one or more panelboard busbars at least partially enclosed in the one or more busbar insulators. The panelboard bus assembly also includes an expansion subassembly including one or more expansion busbars. The one or more expansion busbars are electrically conductive and at least partially exposed. The bus subassembly is configured to mechanically and electrically couple with another bus subassembly via the expansion subassembly.

In another aspect, an expandable panelboard bus assembly for an electrical panelboard system is provided. The panelboard bus assembly includes a bus subassembly including one or more busbar insulators and one or more panelboard busbars at least partially enclosed in the one or more busbar insulators. The panelboard bus assembly further includes an expansion subassembly including one or more expansion busbars, wherein the one or more expansion busbars are electrically conductive and at least partially exposed. The bus subassembly is configured to mechanically and electrically couple with another bus subassembly via the expansion subassembly.

In one more aspect, a method of assembling an expandable electrical panelboard system is provided. The method includes forming a panelboard bus assembly. The panelboard bus assembly includes a bus subassembly including one or more busbar insulators and one or more panelboard busbars at least partially enclosed in the one or more busbar insulators. The panelboard bus assembly further includes an expansion subassembly including one or more expansion busbars, wherein the one or more expansion busbars are electrically conductive and at least partially exposed. The bus subassembly is configured to mechanically and electrically couple with another bus subassembly via the expansion subassembly.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1A is a schematic diagram of a known panelboard system.

FIG. 1B is a schematic diagram of another known panelboard system.

FIG. 2A is a schematic diagram of an example panelboard system.

FIG. 2B shows that the panelboard system illustrated in FIG. 2A is expanded with another bus subassembly.

FIG. 3A shows an example panelboard bus assembly of the panelboard system illustrated in FIG. 2B.

FIG. 3B is a cross-sectional view of the panelboard bus assembly shown in FIG. 3A along cross-sectional line 3B-3B as indicated in FIG. 3A.

FIG. 3C is a perspective view of an example expansion subassembly of the panelboard bus assembly shown in FIG. 3A.

FIG. 3D is a schematic diagram showing assembling of the panelboard bus assembly shown in FIG. 3A by coupling of the expansion subassembly shown in

FIG. 3C with an example bus subassembly.

FIG. 4A is a schematic diagram of another example expansion subassembly.

FIG. 4B shows an example clip of the expansion subassembly shown in FIG. 4A.

FIG. 4C is a schematic diagram showing coupling of the expansion subassembly shown in FIG. 4A with an example bus subassembly.

FIG. 5A shows one more example expandable panelboard bus assembly.

FIG. 5B is a cross-sectional view of the panelboard bus assembly shown in FIG. 5A along cross-sectional line 5B-5B as indicated in FIG. 5A.

FIG. 5C shows one more example expansion subassembly for assembling the panelboard bus assembly shown in FIG. 5A.

FIG. 5D is a side view of the panelboard bus assembly shown in FIG. 5C.

FIG. 5E shows the expansion subassembly shown in FIG. 5C to be coupled with an example insulation cap.

FIG. 5F shows that the expansion subassembly illustrated in FIG. 5C is coupled with the insulation cap.

FIG. 6 is a flow chart of an example method of assembling a panelboard systems shown in FIGS. 2A-5F.

### DETAILED DESCRIPTION

The disclosure includes expandable electrical panelboard systems, panelboard bus assemblies, and methods of assembling panelboard systems and panelboard bus assemblies. Method aspects will be in part apparent and in part explicitly discussed in the following description.

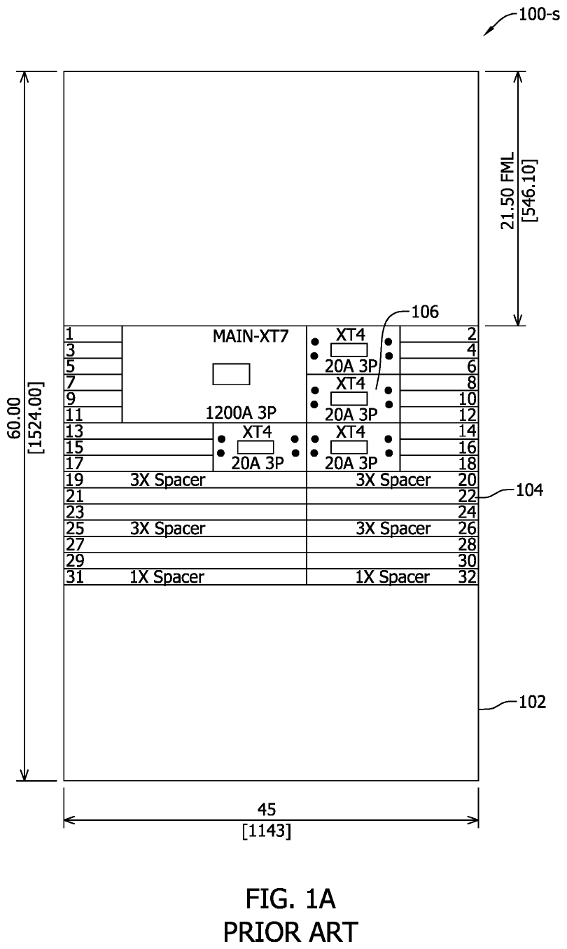

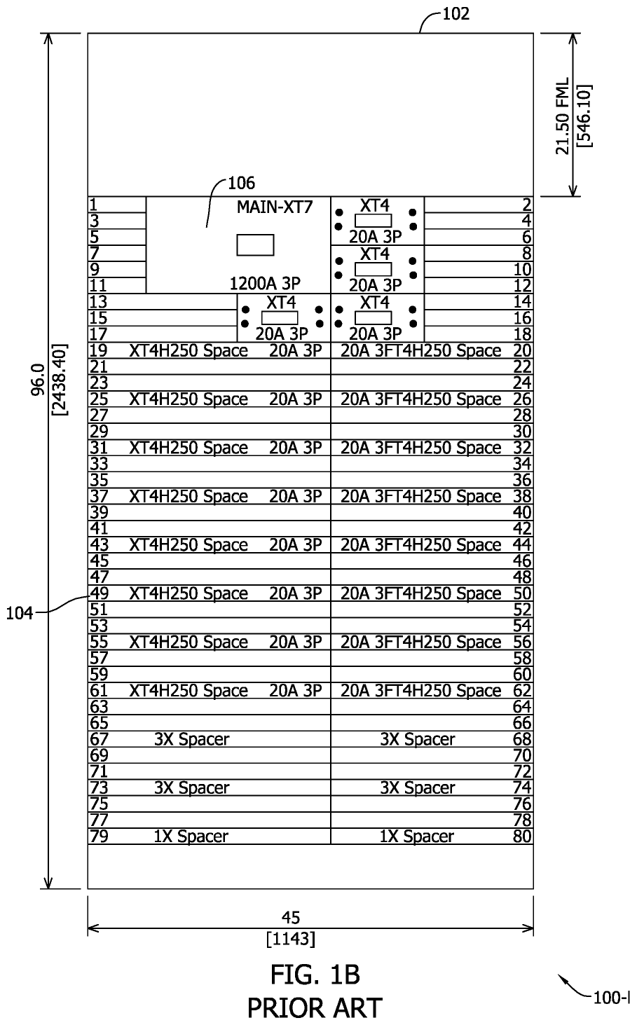

FIGS. 1A and 1B show known panelboard systems 100-s, 100-1. The known panelboard system 100 includes an enclosure 102 and a bus assembly 104. The bus assembly 104 accommodates panelboard electronics 106, such as breakers, which are for controlling delivery of electricity. Known panelboard systems 100 are not expandable. The user needs to choose either a small panelboard system 100-s to minimize the costs, or a large panelboard system 100-1 for the future expansion. The costs of a panelboard system include the costs of the enclosure 102, the bus assembly 104, and panelboard electronics 106. The costs for the sheet metal used in fabricating the enclosure 102 is in a relatively small percentage compared to the costs of the bus assembly 104. Therefore, the costs of the large panelboard system 100-1 is much greater than the costs of the small panelboard system 100-s although the panelboard systems 100 have the same setup of panelboard electronics 106 and the same capacity in power delivery. The value of the expandability in the large known panelboard system 100 is not realized until an uncertain future when the expansion actually occurs. On the other hand, when the need of expansion does arise, the user having the small panelboard system 100-s needs to purchase and assemble a brand new panelboard system.

To expand the known panelboard system, significant costs from parts, labor, and downtime of the system are incurred. To install a larger panelboard system for accommodating more panelboard electronics, the user must power down the system and disconnect all cables and power connections. The old panelboard system needs to be removed before installing the larger panelboard system. Then, all the panelboard electronics and connections in the panelboard system are reinstalled and re-assembled. In an alternative traditional option, the user may purchase a new panelboard system and install the new panelboard system next to the existing panelboard system. The alternative option requires available space, which may be rare.

Accordingly, the nonexpendable known panelboard system 100 is costly in terms of the costs from parts, materials, labor, and/or downtime in addressing the need of expansion, which often arises as the consumers' need for electricity continues to grow.

The systems, assemblies, and methods described herein solve the above problems in at least some of the known panelboard systems. The panelboard systems and panelboard bus assemblies described herein are expandable, where bus subassemblies may be added or removed to accommodate the need without removing the old panelboard system, installing a brand new panelboard system, or leaving portions of the panelboard system unused after having incurred the upfront costs for a relatively large panelboard system. The existing components of the panelboard system, such as the enclosure, the framework, and the existing panelboard bus assemblies, may remain when the panelboard system is expanded, reducing costs in expanding a panelboard system in parts and labor. In expanding a panelboard bus assembly, a person in the field may face the challenge of ensuring the mechanical and electrical connections in the expanded panelboard bus assembly and the compliance with the standards requirements. The systems, assemblies, and methods described herein provide secure mechanical and electrical connections in the panelboard bus assemblies and comply with standard requirements governing panelboard systems and panelboard bus assemblies.

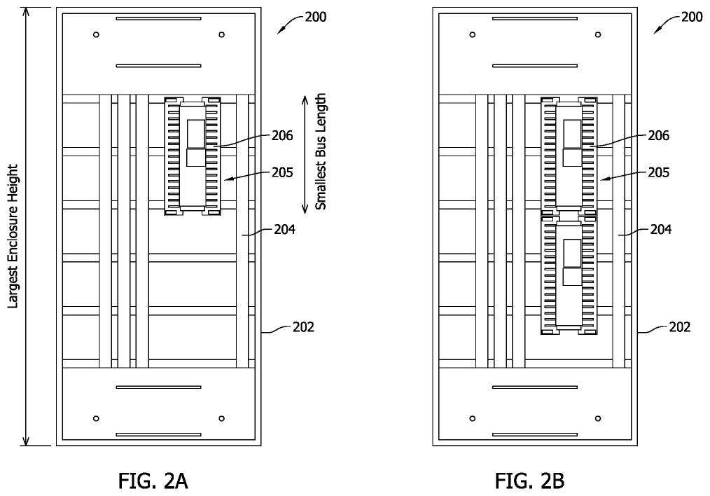

FIGS. 2A and 2B show an example panelboard system 200. FIG. 2A shows the panelboard system 200 at the initial setup. FIG. 2B shows the panelboard system 200 when expanded. In the example embodiment, the panelboard system 200 includes an enclosure 202. The enclosure 202 is fabricated with sheet metal such as aluminum or steel. The panelboard system 200 further includes a framework 204 distributed in the panelboard system 200. The framework 204 provides structures onto which electronics and panelboard bus assemblies 205 are attached. The framework 204 defines various sizes and shapes of apertures and receptacles sized to receive fasteners, plugs, and/or connections for assembling the panelboard system 200.

In the example embodiment, the panelboard system 200 further includes the panelboard bus assembly 205. The panelboard bus assembly 205 includes a bus subassembly 206. The panelboard bus assembly 205 is coupled with the framework 204. At the initial phase, the system may only need one bus subassembly 206. Later to accommodate a growing need, the panelboard bus assembly 205 is expanded with one or more bus subassemblies 206. In the panelboard system 200, the framework 204 and the enclosure 202 are constructed to include extra length in the framework 204 and extra space inside the enclosure 202 to facilitate the expansion.

In operation, to expand the panelboard system 200, another bus subassembly 206 is included into the panelboard system 200 by attaching the new bus subassembly 206 with the existing panelboard bus assembly 205. Electronics are assembled with the new bus subassembly 206. The sizes of components in the panelboard system 200 may be standardized while still meeting changing needs of users. For example, only bus subassemblies 206 in a small number of sizes such as one or two are fabricated. The standardization greatly simplifies the manufacturing processes of the panelboard systems and panelboard bus assemblies, and the supply chain of the manufacturing facilities. The assembling of a panelboard system 200 is also simplified. Instead of removing an old panelboard system and assembling and installing a brand new panelboard system in at least some known systems and methods, during expansion, only additional bus subassemblies are assembled and installed, thereby reducing the costs in parts, material, and labor.

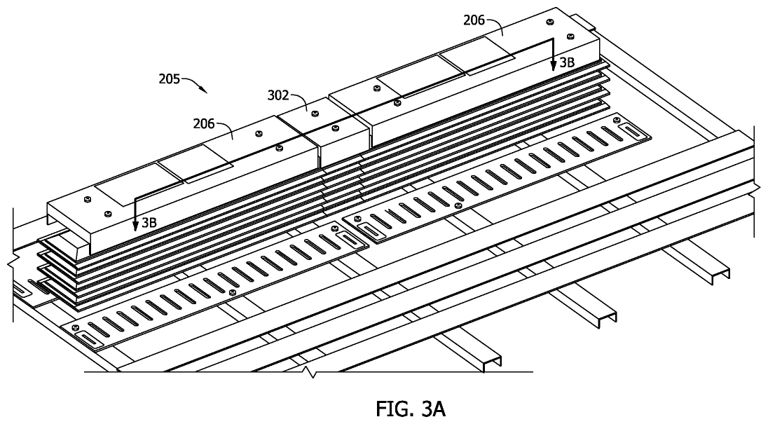

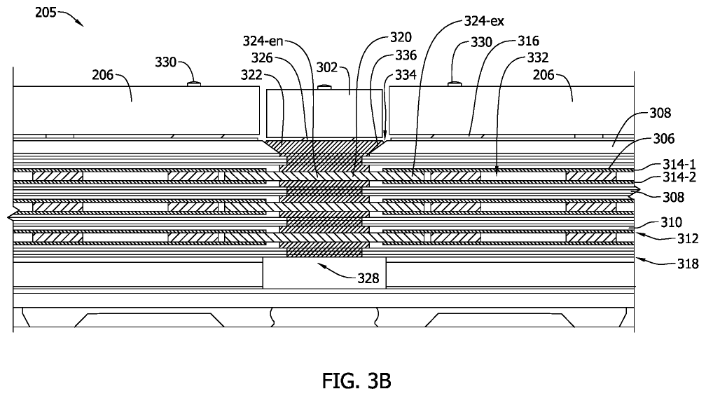

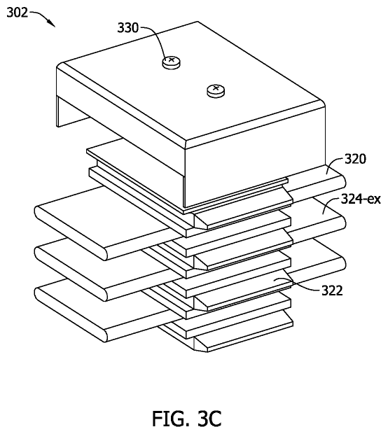

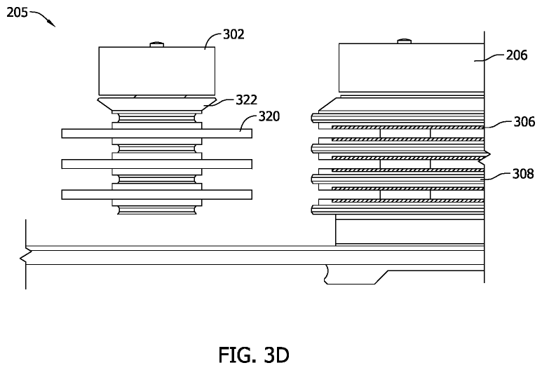

FIGS. 3A-3D show example panelboard bus assembly 205 having example bus subassembly 206 and an example expansion subassembly 302. FIG. 3A shows an expanded panelboard bus assembly 205. FIG. 3B is a cross-sectional view of the panelboard bus assembly 205 shown in FIG. 3A along cross-sectional line 3B-3B as indicated in FIG. 3A. FIG. 3C shows the expansion subassembly 302. FIG. 3D is a schematic diagram of assembling the panelboard bus assembly 205 by coupling the expansion subassembly 302 with the bus subassembly 206. Cross-sectional views of the expansion subassembly 302 and the bus subassembly 206 along cross-sectional line 3B-3B are shown in FIG. 3D.

In the example embodiments, the panelboard bus assembly 205 includes the bus subassembly 206 and the expansion subassembly 302. The bus subassembly 206 includes one or more panelboard busbars 306 and one or more busbar insulators 308. Each panelboard busbar 306 corresponds to a phase of the electricity. The panelboard busbar 306 is at least partially enclosed by the busbar insulator 308. The busbar insulator 308 forms an elongated pocket 310 sized to receive the panelboard busbar 306 therein. The pocket 310 defines an insulator aperture 312 such that the panelboard busbar 306 at the insulator aperture 312 is exposed and may establish electrical connections with one or more electrically conductive components. The bus subassembly 206 complies with standards, such as Underwriters Laboratory (UL) 67, that govern electrical panelboards. For example, the panelboard busbars in the panelboard system are insulated by insulators such that the panelboard system meets a finger safe rating and prevents access to energized parts, thereby ensuring safety of the panelboard system and the field workers. In some embodiments, for one phase of electricity, the panelboard busbar 306 are split into two panelboard sub-busbars 314, where a first panelboard sub-busbar 314-1 is at least partially enclosed in one busbar insulator 308 and a second panelboard sub-busbar 314-2 is at least partially enclosed in another busbar insulator 308. A panelboard busbar 306 being split into two panelboard sub-busbars 314 is advantageous in achieving a desired cross-sectional area of the conductor of the panelboard busbar 306 for carrying current at a certain rating while reducing one or more dimensions of the conductor. The busbar insulators 308 and the panelboard busbars 306 may form into a busbar stack 318, where one busbar insulator 308 is positioned over another busbar insulator 308 and one panelboard busbar 306 positioned over another panelboard busbar 306 in the radial direction.

In the example embodiments, the panelboard system 200 further includes a busbar bolt 316. The busbar bolt 316 is coupled with the busbar stack 318 of busbar insulators 308 and panelboard busbars 306. The busbar bolt 316 may be a fastener and extend through the busbar stack 318. The torque of the busbar bolt 316 for compressing the busbar stack 318 may be adjusted by fastening or loosening the busbar bolt 316 in a desired amount. The busbar bolt 316 may be threaded. The torque may be adjusted by rotating the busbar bolt 316 into or out of the busbar stack 318 in a desired amount. Alternatively or additionally, the busbar insulators 308 and the panelboard busbars 306 are assembled together via other mechanism such as using adhesives.

In the example embodiment, the expansion subassembly 302 includes one or more expansion busbars 320. Each expansion busbar may correspond to a phase of the electricity. The expansion busbars 320 are electrically conductive. The expansion busbars 320 are at least partially exposed, where at least part of the expansion busbars 320 are not insulated before the expansion subassembly 302 is coupled with other components of the panelboard system 200. As used herein, an electrically conductive component is exposed when the component is not covered with an insulative material before the component is coupled with another component. The expansion subassembly 302 further includes one or more expansion insulators 322. Each expansion busbar 320 is at least partially enclosed by the one or more expansion insulators 322, where at least part of the expansion busbar 320 is surrounded and covered by the expansion insulators 322. As a result, the expansion busbar 320 includes an exposed portion 324-ex and an enclosed portion 324-en, where the exposed portion 324-ex is exposed from the expansion insulators 322 and the enclosed portion 324-en is enclosed in the expansion insulators 322 and insulated by the expansion insulators 322. The expansion busbar 320 includes two exposed portions 324-ex with the enclosed portion 324-en positioned therebetween, facilitating expansion of the panelboard bus assembly 205, where two bus subassemblies 206 may be coupled with the expansion subassembly 302. In the depicted embodiment, the expansion insulators 322 have a side shape or the shape of a side complementary with the side shape of the bus subassembly 206 (see FIG. 3B). An expansion stack 328 may be formed as one expansion insulator 322 is positioned over another expansion insulator 322 and one expansion busbar 320 is positioned over another expansion busbar 320 in the radial direction.

In the example embodiment, the expansion subassembly 302 further includes an expansion bolt 326. The expansion bolt 326 is coupled with the expansion stack 328 of expansion insulators 322 and expansion busbars 320. For example, the expansion bolt 326 may be a fastener and extend through the expansion stack 328. The torque of the expansion bolt 326 for compressing the expansion stack 328 may be adjusted by fastening or loosening the expansion bolt 326 in a desired amount. The expansion bolt 326 may be threaded. The torque may be adjusted by rotating the expansion bolt 326 into or out of the expansion stack 328 in a desired amount. Alternatively or additionally, the expansion insulators 322 and the expansion busbars 320 are assembled together via other mechanism such as using adhesives.

In the example embodiment, the expansion subassembly 302 further includes an indicator 330 used to indicate whether the expansion subassembly 302 is energized. For example, if electricity passes through the expansion subassembly 302, the indicator 330 is lit, and when no electricity passes through the expansion subassembly 302, the indicator 330 is not lit. The indicator 330 may serve as a warning to a field worker about energized busbars. Indicators 330 may be included in bus subassemblies 206 for the warning purposes.

In operation, to couple the expansion subassembly 302 with the bus subassembly 206, the expansion busbars 320 are aligned with the gaps 332 defined between the two panelboard sub-busbars 314 of a panelboard busbar 306. The expansion busbars 320 are inserted into the gaps 332 with one expansion busbar 320 being inserted into one gap 332. The expansion subassembly 302 may be inserted into the bus subassembly 206 as far as the gaps 332 and the expansion busbars 320 permit. In the depicted embodiment, the expansion subassembly 302 has a side shape complementary with the side shape of the bus subassembly 206 such that when the expansion subassembly 302 is assembled with the bus subassembly 206, the spacing 334 between the expansion subassembly 302 and the bus subassembly 206 is relatively small. The side shapes of the expansion subassembly 302 and the bus subassembly 206 may be irregular such as being zigzagged or serpentine, thereby reducing or restricting the entry of substance such as water into the panelboard bus assembly 205. The expansion subassembly 302 and the bus subassembly 206 are interwoven with one another, where some part of the bus subassembly 206 is inserted into the expansion subassembly 302 and some part of the expansion subassembly 302 is inserted into the bus subassembly 206. In some embodiments, the coupling points 336 between the expansion subassembly 302 and the bus subassembly 206 may be sealed with a sealant, further limiting the entry of substance into the panelboard bus assembly 205. Another bus subassembly 206 may be coupled with the expansion subassembly 302 at the other side of the expansion subassembly 302, thereby expanding the panelboard bus assembly 205.

When assembled, the expansion subassembly 302 and the bus subassembly 206 are electrically coupled with one another, where the expansion busbars 320 are coupled with the panelboard busbars 306. For example, the expansion busbars 320 are inserted into the gap 332 between two panelboard sub-busbars 314 of a panelboard busbar 306, establishing electrical connection. The mechanical and electrical connections and coupling between the expansion subassembly 302 and the bus subassembly 206 are strengthened by the busbar bolt 316 and/or the expansion bolt 326. The coupling strength may be adjusted by adjusting the busbar bolt 316 and/or the expansion bolt 326. Further, the compliance with the standard requirements governing the panelboard systems is maintained with panelboard systems 200 and panelboard bus assemblies 205. When the expansion subassembly 302 and the bus subassembly 206 are assembled together, exposed portions 324-ex of the expansion subassembly 302 are insulated by the busbar insulators 308 of the bus subassembly 206. The expanded panelboard bus assemblies 205 are finger safe, providing protection to the field worker from accidentally touching of energized panelboard systems and panelboard bus assemblies. Expanded panelboard bus assemblies 205 along with expansion subassemblies 302 may undergo temperature rise testing of the bus structures to ensure even temperature distribution and meets the requirements on thermal limits under the standards such that heat from the panelboard bus assemblies 205 and expansion subassemblies 302 is effectively dissipated.

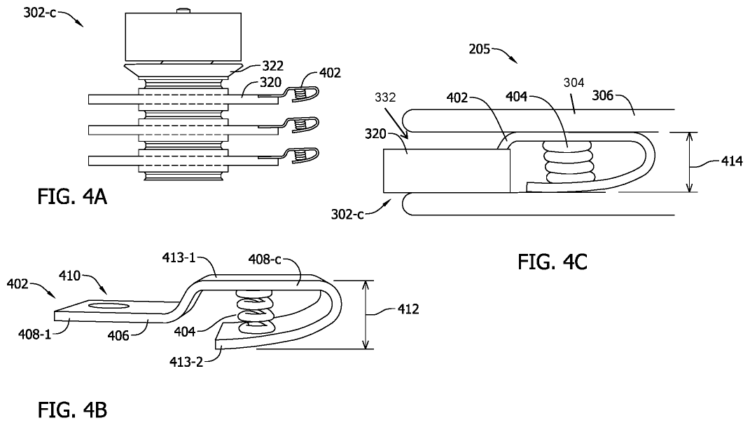

FIGS. 4A-4C show that the coupling between the expansion subassembly 302 and the bus subassembly 206 may be strengthened via a clip 402. FIG. 4A shows another example expansion subassembly 302-c. FIG. 4B shows the example clip 402. FIG. 4C shows that an expansion busbar 320 is coupled with a panelboard busbar 306 of a bus subassembly 206 using the clip 402. In the example embodiment, different from the expansion subassembly 302 shown in FIGS. 3A-3D, the expansion subassembly 302-c includes the clip 402. The clip 402 is fabricated with electrically conductive material such as copper. The clip 402 may include a spring 404. The clip 402 further includes a clip body 406. The clip body 406 may extend from one clip end 408-1 to the other clip end 408-c. The clip body 406 may curve into a curved clip end 408-c and form into a first clip portion 413-1 and a second clip portion 413-2. In some embodiments, the first clip end 408-1 branches into a fork having the first clip portion 413-1 and the second clip portion 413. The spring 404 is attached between the first clip portion 413-1 and the second clip portion 413-2. In other embodiments, the clip 402 does not include a spring 404, where the clip body 406 is fabricated with material having increased elasticity and functions as a spring. For example, the first clip portion 413-1 and the second clip portion 413-2 are compressed toward one another when the clip 402 is being inserted into the gap 332 between panelboard sub-busbars 304, and a force is generated from the compression.

In operation, one or more clips 402 are coupled with the expansion busbar 320. A clip aperture 410 may be defined at the first clip end 408 of the clip 402. An expansion aperture (not show) may be defined in the expansion busbar 320. The clip 402 may be coupled with the expansion busbar 320 by fastening a fastener into the apertures. The clip 402 may be coupled with the expansion busbar 320 via other mechanism such as soldering.

When the expansion subassembly 302 is coupled with the bus subassembly 206, the clip 402 is received in the gap 332 between two panelboard sub-busbars 314 of the panelboard busbar 306. The distance 412 between the first clip portion 413-1 and the second clip portion 413-2 when the spring is not compressed is greater than the width 414 of the gap 332. As a result, when the clip 402 is received in the gap 332, the spring 404 and/or the clip body 406 are compressed, and the force from the compressed spring 404 and/or the compressed clip body 406 presses the clip 402 against the panelboard busbar 306, ensuring the electrical connection between the expansion subassembly 302 and the bus subassembly 206. Using clips 402 to establish electrical and mechanical connection between the expansion subassembly 302 and the bus subassembly 206 may relax the tolerance requirements on the thickness of the expansion busbar 320 and the gap 332 in the bus subassembly 206 (see FIG. 4C).

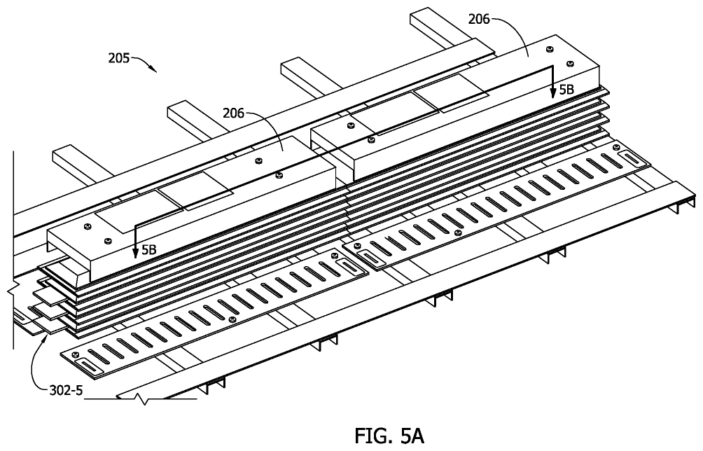

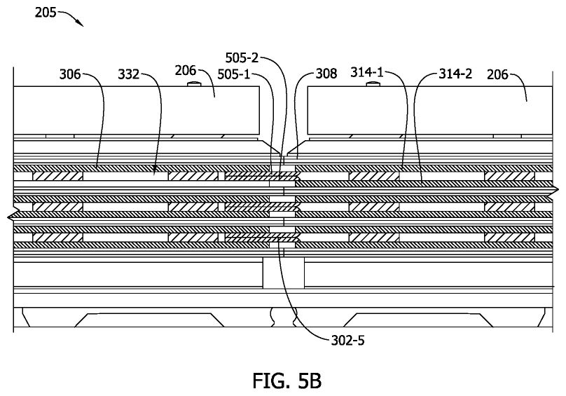

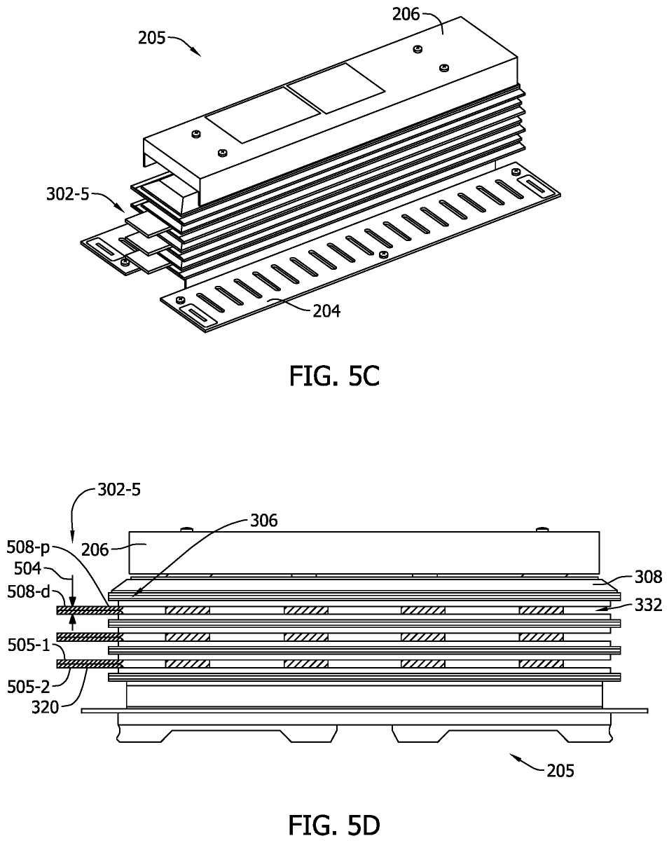

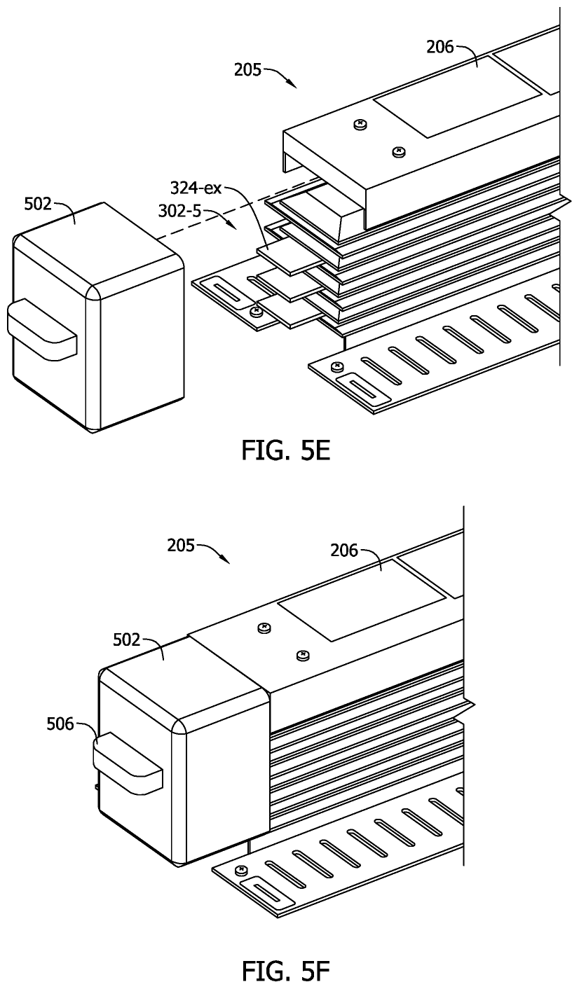

FIGS. 5A-5F show one more example panelboard bus assembly 205 that includes the bus subassembly 206 and one more example expansion subassembly 302-5. FIG. 5A shows that a bus subassembly 206 is coupled with another bus subassembly 206. FIG. 5B is a cross-sectional view of a portion of the assembly shown in FIG. 5A along cross-sectional line 5B-5B as indicated in FIG. 5A. FIG. 5C shows the bus subassembly 206 and the expansion subassembly 302-5 coupled with a framework 204. FIG. 5D is a side view of the assembly shown in FIG. 5C. FIG. 5E shows the assembly illustrated in FIG. 5C to be coupled with an example insulation cap 502. FIG. 5F shows the insulation cap 502 being coupled with the assembly illustrated in FIG. 5C.

In the example embodiment, compared to expansion subassemblies 302 shown in FIGS. 3A-4C, where the expansion subassembly 302 is a distinct component from the bus subassembly 206, the expansion subassembly 302-5 is formed into one unit with the bus subassembly 206. The expansion subassembly 302-5 includes expansion busbars 320. The expansion busbars 320 extend from the panelboard busbars 306. Each expansion busbar 320 may include a first expansion sub-busbar 505-1 and a second expansion sub-busbar 505-2. The first expansion sub-busbar 505-1 extends from the first panelboard sub-busbar 314-1 (see FIG. 5B). The second expansion sub-busbar 505-2 extends from the second panelboard sub-busbar 314-2. The expansion busbars 320 are at least partially exposed, where the exposed portion 324-ex (see FIG. 5E) of the expansion busbar 320 is not insulated, when the expansion subassembly 302-5 is not coupled with another component of the panelboard system 200, such as another bus subassembly 206.

In operation, to expand the panelboard bus assembly 205, the panelboard bus assembly 205 may be coupled with another bus subassembly 206 or another panelboard bus assembly 205 with the bus subassembly 206 and the expansion subassembly 302-5 being formed as one unit. To couple the two panelboard bus assemblies 205 or the panelboard bus assembly 205 with another bus subassembly 206, the expansion busbars 320 of the expansion subassembly 302 are inserted into gaps 332 between neighboring busbar insulators 308. The expansion busbars 320 electrically and mechanically couple with the panelboard busbars 306 in the other bus subassembly 206. In some embodiments, the thickness 504 of the expansion busbar 320 at a distal end 508-d of the expansion busbar 320 distal to the panelboard busbar 306 is greater than the thickness 504 of the expansion busbar 320 at a proximal end 508-p of the expansion busbar 320 proximal to the panelboard busbar 306 (see FIG. 5D). The increased thickness 504 at the distal end 508 may be formed by bending the two expansion sub-busbars 505 away from one another at the distal end 508-d. As a result, the expansion busbar 320 forms into a spring at the distal end 508-d such that the spring is compressed and the two expansion sub-busbars 505 press against the panelboard busbars 306 when the expansion busbar 320 is received in the gap 332, thereby increasing the coupling strength between the expansion subassembly 302 and the other bus subassembly 206. In some embodiments, the expansion subassembly 302 may include one or more clips 402 coupled to one or more ends of the expansion busbars 320.

In the example embodiment, because the expansion busbars 320 are exposed when the panelboard bus assembly 205 is not assembled with another bus subassembly 206, an insulation cap 502 is placed on the expansion busbars 320 to provide protection against energized expansion busbars 320. The insulation cap 502 is fabricated with electrically non-conductive material such as rubber and/or ceramic. The insulation cap 502 may include a handle 506 configured to facilitate the coupling of the insulation cap 502 with the panelboard bus assembly 205 or removal of the insulation cap 502 from the panelboard bus assembly 205.

The expansion of the panelboard bus assembly 205 using the expansion assembly 302-5 saves footprint of the expanded panelboard bus assembly 205, compared to the expanded panelboard bus assembly 205 using a distinct expansion subassembly 302. To expand the panelboard bus assembly, a separate expansion subassembly 302 is not needed. Instead, another bus subassembly 206 or another panelboard bus assembly 205 is coupled with the panelboard bus assembly 205 via the expansion subassembly 302-5.

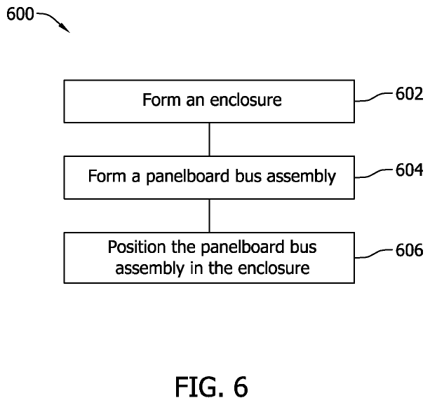

FIG. 6 is a flow chart of an example method 600 of assembling an expandable electrical panelboard system. Electrical panelboard systems may be any panelboard system 200 described herein. In the example embodiments, the method 600 includes forming 602 an enclosure. The method 600 also includes forming 604 a panelboard bus assembly. Panelboard bus assemblies may be any panelboard bus assembly 205 described herein. The method 600 further includes positioning 606 the panelboard bus assembly in the enclosure. In some embodiments, the panelboard system 200 does not include an enclosure. The method 600 does not include forming 602 an enclosure or positioning 606 the panelboard bus assembly in the enclosure. In other embodiments, the panelboard bus assembly 205 may be assembled into an existing enclosure 102 of the panelboard system 200. The method 600 does not include forming 602 an enclosure.

At least one technical effect of the systems and methods described herein includes (a) expandable panelboard bus assemblies; (b) an expansion subassembly for expanding a bus subassembly; (c) an expansion subassembly and a bus subassembly forming into one unit to reduce the footprint of the panelboard bus assembly; and (d) an expansion subassembly including mechanisms to increase the strength in the mechanical and electrical coupling of the expandable panelboard bus assembly.

Example embodiments of systems, assemblies, and methods of panelboards and panelboard buses are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An expandable electrical panelboard system, comprising:
a panelboard bus assembly, the panelboard bus assembly comprising:
a bus subassembly comprising:
one or more busbar insulators; and
one or more panelboard busbars at least partially enclosed in the one or more busbar insulators; and
an expansion subassembly comprising:
one or more expansion busbars, wherein the one or more expansion busbars are electrically conductive and at least partially exposed,
wherein the bus subassembly is configured to mechanically and electrically couple with another bus subassembly via the expansion subassembly.

2. The electrical panelboard system of claim 1, wherein the bus subassembly is a distinct component from the expansion subassembly, the expansion subassembly further comprising:
one or more expansion insulators,
wherein the one or more expansion busbars are at least partially enclosed in the one or more expansion insulators.

3. The electrical panelboard system of claim 2, wherein a side shape of the expansion subassembly is complementary with a side shape of the bus subassembly.

4. The electrical panelboard system of claim 1, wherein the bus subassembly and the expansion subassembly are formed as one unit, the one or more expansion busbars extending from the one or more panelboard busbars and out of the one or more busbar insulators.

5. The electrical panelboard system of claim 4, wherein the expansion busbar comprises a distal end and a proximal end opposite the distal end and proximal to the panelboard busbars, a thickness of the expansion busbar at the distal end being greater than a thickness of the expansion busbar at the proximal end.

6. The electrical panelboard system of claim 4, wherein the panelboard bus assembly further comprises an insulation cap sized to receive the one or more expansion busbars.

7. The electrical panelboard system of claim 1, wherein the one or more expansion busbars further include one or more clips positioned at one or more ends of the one or more expansion busbars.

8. An expandable panelboard bus assembly for an electrical panelboard system, the panelboard bus assembly comprising:
a bus subassembly comprising:
one or more busbar insulators; and
one or more panelboard busbars at least partially enclosed in the one or more busbar insulators; and
an expansion subassembly comprising:
one or more expansion busbars, wherein the one or more expansion busbars are electrically conductive and at least partially exposed,
wherein the bus subassembly is configured to mechanically and electrically couple with another bus subassembly via the expansion subassembly.

9. The panelboard bus assembly of claim 8, wherein the bus subassembly is a distinct component from the expansion subassembly, the expansion subassembly further comprising:
one or more expansion insulators,
wherein the one or more expansion busbars are at least partially enclosed in the one or more expansion insulators.

10. The panelboard bus assembly of claim 9, wherein a side shape of the expansion subassembly is complementary with a side shape of the bus subassembly.

11. The panelboard bus assembly of claim 9, wherein the expansion subassembly further comprises an expansion bolt coupled with the one or more expansion insulators and the one or more expansion busbars.

12. The panelboard bus assembly of claim 8, wherein the bus subassembly and the expansion subassembly are formed as one unit, the one or more expansion busbars extending from the one or more panelboard busbars and out of the one or more busbar insulators.

13. The panelboard bus assembly of claim 12, wherein the expansion busbar comprises a distal end and a proximal end opposite the distal end and proximal to the panelboard busbars, a thickness of the expansion busbar at the distal end being greater than a thickness of the expansion busbar at the proximal end.

14. The panelboard bus assembly of claim 12, further comprising an insulation cap sized to receive the one or more expansion busbars.

15. The panelboard bus assembly of claim 12, wherein the panelboard busbar comprises a first panelboard sub-busbar and a second panelboard sub-busbar, the expansion busbar comprising a first expansion sub-busbar extending from the first panelboard sub-busbar and a second expansion sub-busbar extending from the second panelboard sub-busbar.

16. The panelboard bus assembly of claim 8, wherein the expansion subassembly is interwoven with the bus subassembly.

17. The panelboard bus assembly of claim 8, wherein the one or more expansion busbars further include one or more clips positioned at one or more ends of the one or more expansion busbars.

18. A method of assembling an expandable electrical panelboard system, the method including:
forming a panelboard bus assembly, the panelboard bus assembly including:
a bus subassembly including:
one or more busbar insulators; and
one or more panelboard busbars at least partially enclosed in the one or more busbar insulators; and
an expansion subassembly including:
one or more expansion busbars, wherein the one or more expansion busbars are electrically conductive and at least partially exposed, wherein the bus subassembly is configured to mechanically and electrically couple with another bus subassembly via the expansion subassembly.

19. The method of claim 18, wherein the bus subassembly is a distinct component from the expansion subassembly.

20. The method of claim 18, wherein forming the panelboard bus assembly further comprises forming the expansion subassembly and the bus subassembly as one unit.
